(19) United States
(12) Patent Application Publication
(10) Pub. No.: US 2014/0379559 A1
(43) Pub. Date: Dec. 25, 2014

(54) CLOSED-LOOP STORED VALUE PAYMENT INSTRUMENT BROKERAGE

(71) Applicant: Amazon Technologies, Inc., Reno, NV (US)

(72) Inventors: THOMAS WILLARD PLASTER, Seattle, WA (US); SCOTT KENNETH BISHOP, Seattle, WA (US); JOSHUA KOSSOY FUHRMANN, Seattle, WA (US); ERIC MICHAEL LAIRD, Seattle, WA (US); JONATHAN BLAIR NORWOOD, Seattle, WA (US)

(21) Appl. No.: 13/925,283

(22) Filed: Jun. 24, 2013

(51) Int. Cl. G06Q 20/08

(52) U.S. Cl. CPC G06Q 20/08
USPC 705/39

(57) ABSTRACT

Closed-loop stored value payment instruments may be issued, sold and managed on behalf of a merchant through a third party electronic commerce system. Upon purchase of a closed-loop stored value payment instrument through the third party electronic commerce system, a payment aggregator may be notified of the purchase and the closed-loop stored-value payment instrument may be activated. A printer or other manufacturer may also notified of the purchase so that a closed-loop stored value payment instrument embodied in a physical card, may be created on demand in response to the purchase and then shipped to the purchasing customer on behalf of the merchant.

### BACKGROUND

Many sellers, merchants, or businesses (generally referred to herein as “merchants”) wish to offer prepaid or stored value payment instruments, such as gift card instruments, to their customers. Such stored value payment instruments may be used to purchase or rent goods or services from the business offering the stored valued payment instrument or from other businesses. Larger businesses may have a sufficient number of customers or volume of transactions to justify operating their own infrastructure for offering and processing prepaid or stored value payment instruments. Smaller businesses may wish to offer similar stored value payment instruments to their customers, but may not have enough customers or volume of transactions to provide the service economically.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a pictorial diagram of an example of a user interface, such as a network page, that offers a closed-loop stored value payment instrument for sale through an electronic commerce system.

FIG. 2 is a schematic block diagram of a networked environment according to various embodiments of the present disclosure.

FIG. 3 is a pictorial diagram of an example of a user interface rendered by a client computing device in the networked environment of FIG. 2 according to various embodiments of the present disclosure.

FIG. 4 is a flowchart illustrating one example of functionality implemented by a brokerage application executed in a computing environment in the networked environment of FIG. 2 according to various embodiments of the present disclosure.

FIG. 5 is a schematic block diagram that provides one example illustration of a computing environment employed in the networked environment of FIG. 2 according to various embodiments of the present disclosure.

### DETAILED DESCRIPTION

Disclosed are various embodiments for selling closed-loop stored value payment instruments on behalf of one or more parties for whom it would otherwise be uneconomical to do so. One example of an open loop payment instrument is a stored value payment instrument issued by a bank or a credit card company and redeemed by different entities or providers. In contrast, a closed-loop payment instrument may be a stored value payment instrument issued by, or on behalf of, a specific provider or entity, such as a specific merchant or seller, and redeemed by the issuing provider.

In some embodiments of the present disclosure, merchants or sellers, such as small businesses, register with a brokerage system and supply necessary information to the brokerage system for issuing and processing closed-loop stored value payment instruments. Accordingly, the merchant or seller need not issue or manage the issuance of stored value payment instruments itself. Moreover, the information supplied by the merchant or seller may then be provided to one or more payment aggregators that process transactions made with closed-loop stored value payment instruments, which management may be difficult and costly, particularly for a small business. Therefore, the merchant or seller also need not process stored value payment instrument transactions itself.

In accordance with yet other aspects of the present disclosure, the closed-loop stored value payment instruments issued and managed on behalf of the merchant or seller may be offered for sale through a third party electronic commerce system. Accordingly, an additional sales channel for stored value payment instruments is provided beyond the merchant's or seller's own physical locations and/or electronic commerce sites. Upon purchase of a closed-loop stored value payment instrument through the third party electronic commerce system, a payment aggregator may be notified of the purchase and the closed-loop stored-value payment instrument may be activated. In some embodiments, a printer or other manufacturer is also notified of the purchase so that a closed-loop stored value payment instrument, such as an instrument embodied in a physical card, may be created on demand, e.g., in response to the purchase. Such physical cards may be made of plastic, such as polyvinyl chloride, polyethylene terephthalate based polyesters, acrylonitrile butadiene styrene or polycarbonates. In yet other embodiments, the closed-loop stored value payment instrument may be embodied in a “smart” card, e.g., a physical card equipped with one or more integrated circuits. In yet other embodiments, the closed-loop stored valued payment instrument is embodied in a device, such as a fob, including a radio-frequency (RFID) tag. In the following discussion, a general description of a brokerage system and its components for issuing, selling and managing such closed-loop stored value payment instruments on behalf of merchants or sellers is provided, followed by a discussion of the operation of the same.

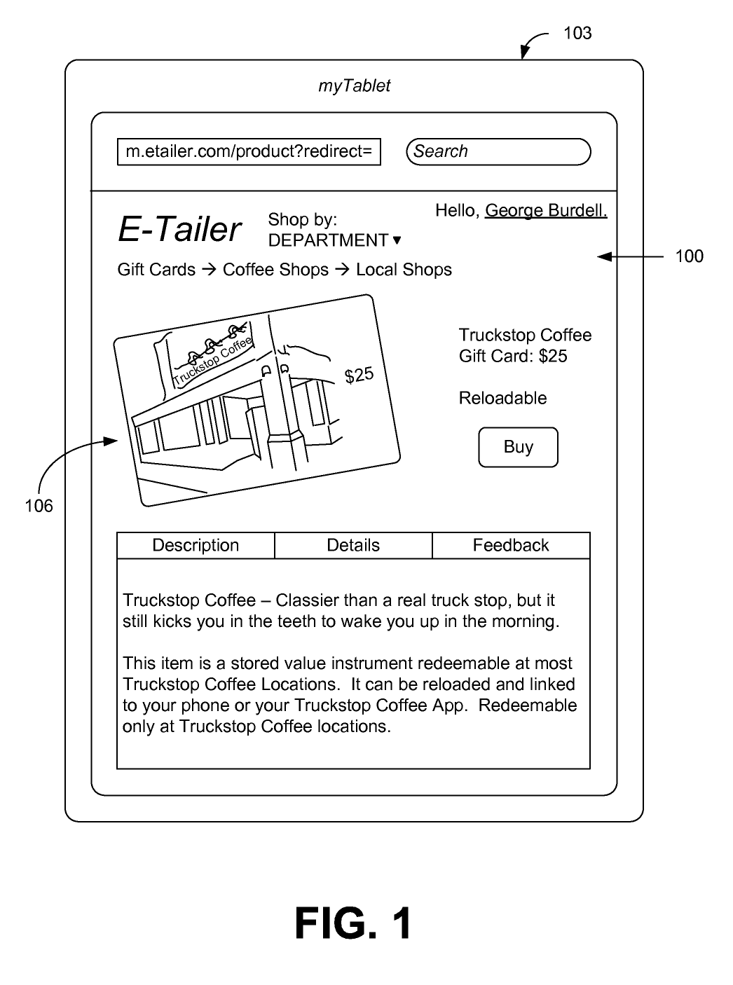

With reference to FIG. 1, shown is an embodiment of an example user interface 100, such as a web page or other network page, rendered on a client device 103, such as a tablet. The user interface 100 permits a user of the client device 103 to purchase a closed-loop stored value payment instrument 106 through an electronic commerce system. As noted above, the closed-loop stored value payment instrument 106 may be an instrument redeemable only at a specific merchant, business, or similar entity. A closed-loop stored value payment instrument 106 for a sufficiently large merchant may be preexisting and ready for immediate fulfillment by the electronic commerce system and subsequent use by a purchaser. However, in the case of a smaller business, a closed-loop stored value payment instrument 106 may not be readily available. Thus, the brokerage system may coordinate creation of the closed-loop value payment instrument 106 with one or more additional parties as described below.

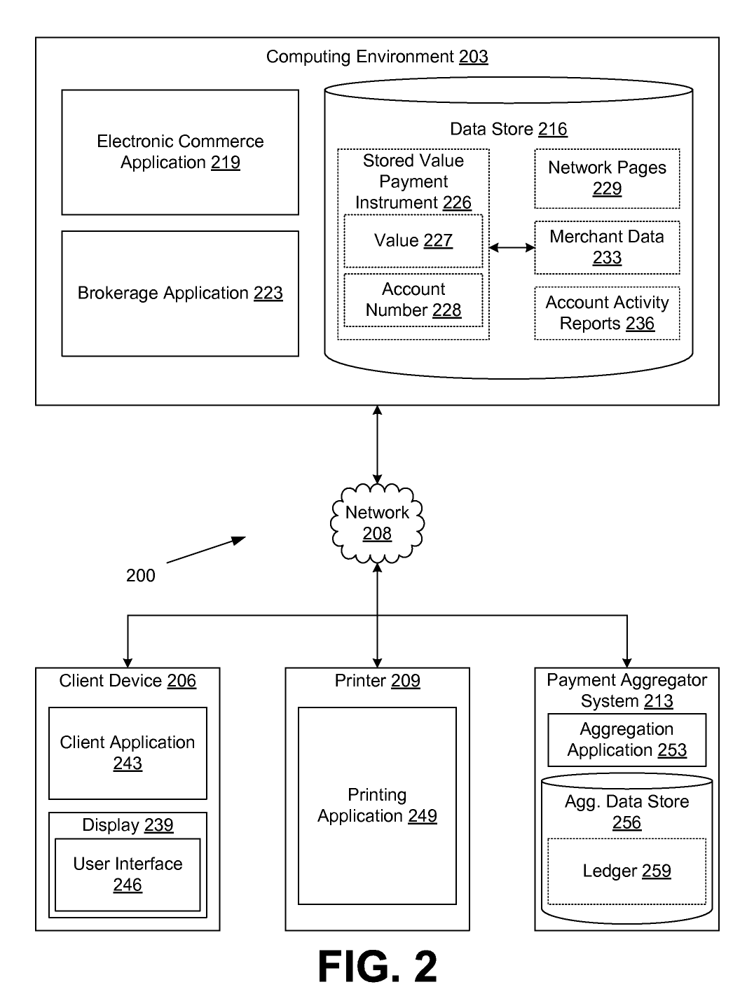

With reference to FIG. 2, shown is a networked environment 200 according to various embodiments. The networked environment 200 includes a computing environment 203, a client device 206, a printer 209 and a payment aggregator system 213, which are in data communication with each other via a network 208. The network 208 includes, for example, the Internet, intranets, extranets, wide area networks (WANs), local area networks (LANs), wired networks, wireless networks, cable networks, satellite networks, or other suitable networks, etc., or any combination of two or more such networks.

The computing environment 203 may include, for example, a server computer or any other system providing computing capability. Alternatively, the computing environment 203 may employ a plurality of computing devices that may be arranged, for example, in one or more server banks or computer banks or other arrangements. Such computing devices may be located in a single installation or may be distributed among many different geographical locations. For example, the computing environment 203 may include a plurality of computing devices that together may include a hosted or “cloud” computing resource, a grid computing resource, and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. Also, various data may be stored in a data store 216 that is remotely or locally accessible to the computing environment 203. The data store 216 may be representative of a plurality of data stores 216 as can be appreciated. The data stored in the data store 216, for example, is associated with the operation of the various applications and/or functional entities described below.

The components executed on the computing environment 203, for example, include an electronic commerce application 219, a brokerage application 223, and other applications, services, processes, systems, engines, or functionality not discussed in detail herein. The electronic commerce application 219 may be executed in order to facilitate the purchase of items, such as closed-loop stored value payment instruments 226, over the network 208. The electronic commerce application 219 may also perform various backend functions associated with the network presence of a merchant in order to facilitate the purchase of items such as closed-loop stored value payment instruments 226 as will be described. For example, the electronic commerce application 219 generates network pages 229 such as web pages or other types of network content that are provided to client devices 206 for the purposes of selecting items for purchase, rental, download, lease, or other form of consumption as will be described.

The brokerage application 223 may facilitate the exchange of information between one or more merchants (who wish to offer closed-loop stored value payment instruments 226 for sale through the electronic commerce application 219), the printer 209 (if the instrument is being distributed in physical form instead of, or in addition to, digital form), the payment aggregator system 213, and the electronic commerce application 219. The brokerage application 223 may obtain merchant data 233, as further described herein, sufficient to permit closed-loop stored value payment instruments 226 to be sold to a customer, printed with the printer 209, and registered with a payment aggregator system 213 as will be further described herein. In some embodiments, the brokerage application 223 may facilitate processing of closed-loop stored value payment instruments 226 through point-of-sale systems operated by the merchant or seller on behalf of whom the closed-loop stored value payment instrument 226 was issued.

In some embodiments, the brokerage application 223 may also provide notification functionality. For example, the brokerage application 223 may notify merchants when a closed-loop stored value payment instrument 226 has been purchased through the electronic commerce application 219. The brokerage application 223 may also notify purchasers or holders if the balance stored on the closed-loop stored value payment instrument 226 falls below a threshold. In some embodiments, the brokerage application 223 may also permit balance inquiries by purchasers or holders of the closed-loop stored value payment instrument 226 or the transfer of funds between stored value payment instruments.

The data stored in the data store 216 may include, for example, data regarding closed-loop stored value payment instruments 226, network pages 229, merchant data 233, account activity reports 236 and potentially other data. Closed-loop stored value payment instruments 226 may include one or more types of instruments, embodied in physical cards or mobile applications with payment functionality, and associated with an underlying account that acts as a store of monetary or other redeemable currency, such as loyalty points. The account may have been previously credited with a value 227 equal to a deposited sum of money or currency, such as the purchase price of the closed-loop stored value payment instrument 226 or the “face-value” of the closed-loop stored value payment instrument 226 when sold. In some embodiments, the account may be “reloaded” by having additional sums of money or currency deposited in or credited to the account. Each closed-loop stored value payment instrument 226 may be identified by a corresponding account number 228.

Stored value card payment instruments may be considered “closed-loop” if they can be redeemed only for items, goods, or services provided by the issuer of the payment instrument. In contrast, payment instruments may be considered “open-loop” if they may be redeemed for items, goods, or services provided by a party other than the issuer of the payment instrument. While, in some embodiments, the issuer of a closed-loop stored value payment instrument 226 may also be the seller of the closed-loop stored value payment instrument 226, the seller may be a third-party in other embodiments where the seller is offering the stored value payment instrument on behalf of the issuer. As such, closed-loop stored value payment instruments 226 may be associated with the merchant data 233 of the issuer.

Network pages 229 may include may include static content or code that dynamically generates the network page when requested with the client device 206 or other device. The code may be written in any suitable programming language such as, for example, PHP®, PERL®, Objective-C®, JAVA®, Ruby, etc. Also, the network pages 229 may include code configured to be executed or interpreted within the client device 206 in order to facilitate dynamic rendering of the network page 229. Such code may be referred to as an executable and may be written in any suitable programming language such as, for example, JavaScript, Java or other languages. Static elements may be expressed, for example, in hypertext markup language (HTML), extensible markup language (XML), and/or any other language suitable for creating network pages 229.

Merchant data 233 may include the name of the merchant, an account number for a demand deposit account (“DDA”) or other transactional banking account associated with the merchant, a bank routing number associated with the bank account, information related to the point-of-sale infrastructure of the merchant, and other similar information. Some embodiments of the present disclosure may also include financial information related to the merchant, such as a credit score, credit report, and other credit risk data.

Account activity reports 236 may include data related to one or more closed-loop stored value payment instruments 226 sold through the electronic commerce application 219 on behalf of a merchant. Account activity reports 236 may include the total number of closed-loop stored value payment instruments 226 sold or otherwise outstanding. Account activity reports 236 may also include the total amount of money or currency outstanding and not yet redeemed. In some embodiments, account activity reports 236 may also permit a merchant to view data related to individual closed-loop stored value payment instruments 226, including the account number, transaction history, and outstanding balance of an individual closed-loop stored value payment instrument 226. In some embodiments, account activity reports 236 for individual closed-loop stored value payment instruments 226 may also be available to or provided to purchasers of or holders of purchased and/or activated closed-loop stored value payment instruments 226.

The client computing device 206 may be representative of a plurality of client devices that may be coupled to the network 208. The client device 206 may include, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability, such as the client device 103 illustrated in FIG. 1. The client device 206 may include a display 239. The display 239 may include, for example, one or more devices such as a liquid crystal display (LCD), a gas plasma-based flat panel display, an organic light emitting diode (OLED) display, an electrophoretic ink (E ink) display, an LCD projector, or other type of display device.

The client device 206 may be configured to execute various applications such as a client application 243 and/or other applications. The client application 243 may be executed in the client device 206, for example, to access network content served by the computing environment 203 and/or other servers, thereby rendering a user interface 246 on the display 239. The user interface 246 may correspond to a number of user interfaces such as the example user interface 100 depicted in FIG. 1. To this end, the client application 243 may include, for example, a browser, a dedicated application, etc., and the user interface 246 may include a network page 229, an application screen, etc. The client device 206 may be configured to execute applications beyond the client application 243 such as, for example, email applications, social networking applications, word processors, spreadsheets, voice telephone applications, mobile applications, and/or other applications.

The printer 209 may include a hardware device configured to print a physical form of closed-loop stored value instrument 226 that may be used to access a closed-loop stored value payment account. Such physical forms may include magnetic stripe cards, cards displaying a redemption code, cards displaying a bar code, or similar cards, or may include stickers or other physical objects with such codes. The printer 209 may be configured to generate payment cards from blanks in response to receiving a notification from the brokerage application 223 that a closed-loop stored value payment instrument 226 has been purchased. The printer 209 may be further configured to print “on-demand,” such that printing of payment cards for closed-loop stored value payment instruments 226 occurs as needed, which may include printing of only a single payment card on behalf of a single merchant.

The printer 209 may be configured to execute various applications to aid in the creation of payment cards. For example, a printing application 249 may be executed in the printer 209 to permit switching printing from a first payment card for a first merchant to printing of a second payment card for a second merchant and similar on-demand printing. The printing application 249 may be further executed to receive notifications sent from the brokerage application 223 that a closed-loop stored value payment instrument 226 has been purchased through the electronic commerce application 219. The printing application 249 may also be configured to inform the brokerage application 223, or other applications such as an aggregation application 253, that a physical payment card has been printed.

The payment aggregator system 213 may process transactions made using a closed-loop stored value payment instrument 226. The payment aggregator system 213 may include, for example, a server computer or any other system providing computing capability in data communication with one or more point-of-sale systems (not pictured) via the network 208. Alternatively, the payment aggregator system 213 may employ a plurality of computing devices that are arranged, for example, in one or more server banks or computer banks or other arrangements. Such computing devices may be located in a single installation or may be distributed among many different geographical locations. For example, the payment aggregator system 213 may include a plurality of computing devices that together may include a hosted or “cloud” computing resource, a grid computing resource, and/or any other distributed computing arrangement. In some cases the payment aggregator system 213 may correspond to an elastic computing resource where the allotted capacity of processing, network, storage, or other computing-related resources may vary over time.

Various applications and/or other functionality may be executed in the payment aggregator system 213 according to various embodiments, including an aggregation application 253. Also, various data may be stored in an aggregator data store 256 that is remotely or locally accessible to the payment aggregator system 213. The aggregator data store 256 may be representative of a plurality of aggregator data stores 256 as can be appreciated. The data stored in the aggregator data store 256, such as a ledger 259, may be associated with the operation of the aggregation application 253 and the brokerage application 223 as described below.

The aggregation application 253 may be executed to create accounts for issued closed-loop stored value payment instruments, track account balances for issued closed-loop stored value payment instruments 226, load value to and debit value from the accounts associated with the closed-loop stored value payment instruments 226, process payments made with issued closed-loop stored value payment instruments 226, and disburse funds to or otherwise credit merchants for purchases made using issued closed-loop stored value payment instruments 226. The aggregation application 253 may also be executed in the payment aggregator system 213 to perform other related functions. As will be appreciated by those skilled in the art, an operator of the payment aggregator system 213 may be responsible, in some embodiments, for creation and management of the accounts associated with the issued closed-loop stored value payment instruments 226 in accordance with various banking, state and/or federal regulations.

The ledger 259 may include a list, table, or other data structure that tracks issued closed-loop stored value payment instruments 226. For each closed-loop stored value payment instrument 226 issued on behalf of a merchant, the ledger 259 may store the account number 228 of the closed-loop stored value payment instrument 226, an account balance corresponding to the value 227 of the closed-loop stored value payment instrument 226, a transaction history, and potentially other data. This permits changes in the value 227 of each issued closed-loop stored value payment instrument 226 to be tracked. In some embodiments, a single or “master” ledger 259 is used for all issued closed-loop stored value payment instruments 226. In other embodiments of the present disclosure a unique ledger 259 is used to track a respective closed-loop stored value payment instrument 226.

Although the embodiment illustrated in FIG. 2 shows the computing environment 203, the client device 206, the printer 209, and the payment aggregator system 213 as physically separate components to facilitate disclosure, it is understood that embodiments other than those illustrated may combine one or more of the computing environment 203, the client device 206, the printer 209, and the payment aggregator system 213 together. For example, some embodiments of the present disclosure may include either the printer 209 or the payment aggregator system 213 within the computing environment 203. Other embodiments may include both the printer 209 and the payment aggregator system 213 within the computing environment 203. Such combinations may occur even if the computing environment 203, client device 206, printer 209, and payment aggregator system 213 are owned, operated or otherwise controlled by separate and distinct parties.

Next, a general description of the operation of the various components of the networked environment 200 is provided. To begin, a client device 206 may register a merchant, seller, or similar user of the client device 206 with the brokerage application 223. As part of the registration request, merchant data 233 may be supplied to the brokerage application 223 and stored in the data store 216 by the brokerage application 223. Registration may occur, for example, as a result of interacting with one or more network pages 229 rendered on the display 239 of the client device 206 as a portion of the user interface 246. In some embodiments, part of the registration process may include listing one or more closed-loop stored value payment instruments 226 for sale or other acquisition through the electronic commerce application 219. In other words, registration may occur as part of the listing process.

Upon registration, the brokerage application 223 may send the merchant data 233 to the aggregation application 253 located on the payment aggregator system 213. In response to receiving merchant data 233, the aggregation application 253 may create one or more entries in the ledger 259 corresponding to the merchant. Such entries in the ledger 259 may permit the aggregation application 253 to track and process subsequent transactions made using closed-loop stored value payment instruments 226 sold through the electronic commerce application 219 on behalf of the merchant.

At some point after registration, a closed-loop stored value payment instrument 226 is sold or otherwise provided. In some embodiments, the sale may be through the electronic commerce application 219 as a result of an interaction with a network page 229 representing a user interface 246 through which the electronic commerce application 219 sells closed-loop stored value payment instruments 226. In other embodiments, the merchant may sell closed-loop stored value payment instruments 226 issued on its behalf on its premises, with activation occurring at or after the time of the sale through the brokerage application 223.

In some embodiments, following sale of the closed-loop stored value payment instrument 226, the brokerage application 223 notifies a printing application 249 executing in a printer 209, of the sale. As part of the notification, the brokerage application 223 may include merchant data 233 related to the closed-loop stored value payment instrument 226.

The printing application 249 may then cause the printer 209 to print a closed-loop stored value payment instrument 226 in physical form in order to create a physical payment card, gift card, rebate card, payroll card, cafeteria card, travel card, loyalty card or similar card that is capable of accessing funds associated with the closed-loop stored value payment instrument 226. In one particular embodiment, the printer 209 will print a physical card from a blank. The printer 209 may print in a “just-in-time” or “on-demand” manner, whereby cards are only printed as closed-loop stored value payment instruments 226 are sold. In other embodiments, the printer 209 may print cards in batches for each merchant offering closed-loop stored value payment instruments 226. Upon generation of the payment instrument, such as the card, the printing application 249 may respond to the brokerage application 223 to confirm that the payment instrument has been generated.

In other embodiments, the closed-loop stored value payment instrument 226 is embodied in a digital medium, such as a digital wallet, a mobile payment application or an electronically accessible payment account. In such embodiments, a client application 243 executing in the client device 206 may be used to access the closed-loop stored value payment instrument 226. For example, the client application 243 may cause the client device 206 to transmit information related to the closed-loop stored value payment instrument 226 to a point-of-sale terminal using near-field communications (“NFC”), radio frequency identification (“RFID”), or similar wireless communication technologies. Such technologies may also be employed in embodiments where the closed-loop stored value instrument 226 is embodied in a physical device such as a smart card or fob, as described above. As another example, the client application 243 may cause a redemption code, bar code, or similar code to be rendered on the display 239 of the client device 206. Such a code may encode information related to the closed-loop stored value payment instrument 226 such that a point-of-sale terminal may read, scan, or otherwise recognize the code in order to receive the information related to the closed-loop stored value payment instrument 226.

The brokerage application 223 may also notify the aggregation application 253 of the sale of the closed-loop stored value payment instrument 226. The notification generally identifies the merchant with which the closed-loop stored value payment instrument 226 may be redeemed, the value 227 of closed-loop stored value payment instrument 226, the account number 228 to be used to identify the stored value payment instrument, and any other necessary data to permit the aggregation application 253 to manage transactions made with the closed-loop stored value payment instrument 226. Notification of the aggregation application 253 may occur before, concurrently with, or after notification is provided to the printing application 249 as described above. Upon recording the closed-loop stored value payment instrument 226 in the ledger 259, the aggregation application 253 may respond to the brokerage application 223 to confirm that the aggregation application 253 is ready to process transactions made using the closed-loop stored value payment instrument 226.

The brokerage application 223 may wait to receive confirmations and/or responses from the printing application 249 and the aggregation application 253 that each has completed its respective task, as described above. Upon receiving such a confirmation and/or response from both the printing application 249 and the aggregation application 253, the brokerage application 223 may notify the electronic commerce application 219 that it may fulfill the purchase of the closed-loop stored value payment instrument 226.

Subsequently, the closed-loop stored value payment instrument 226 may be redeemed using a point-of-sale terminal (not pictured) or similar system. In some embodiments, the closed-loop stored value payment instrument 226 may also be redeemed while making a purchase through a merchant website. These transactions may be sent to the aggregation application 253 for processing, and may be approved or denied, in whole or in part, based upon the value 227 of the closed-loop stored value payment instrument 226 in the ledger 259.

The brokerage application 223 may also generate one or more account activity reports 236. The brokerage application 223 may query the aggregation application 253 or the aggregator data store 256 directly to retrieve information necessary to compile the account activity report 236. Such account activity reports 236 may be presented to the issuer with a user interface 246 such as a network page 229 requested with the client device 206.

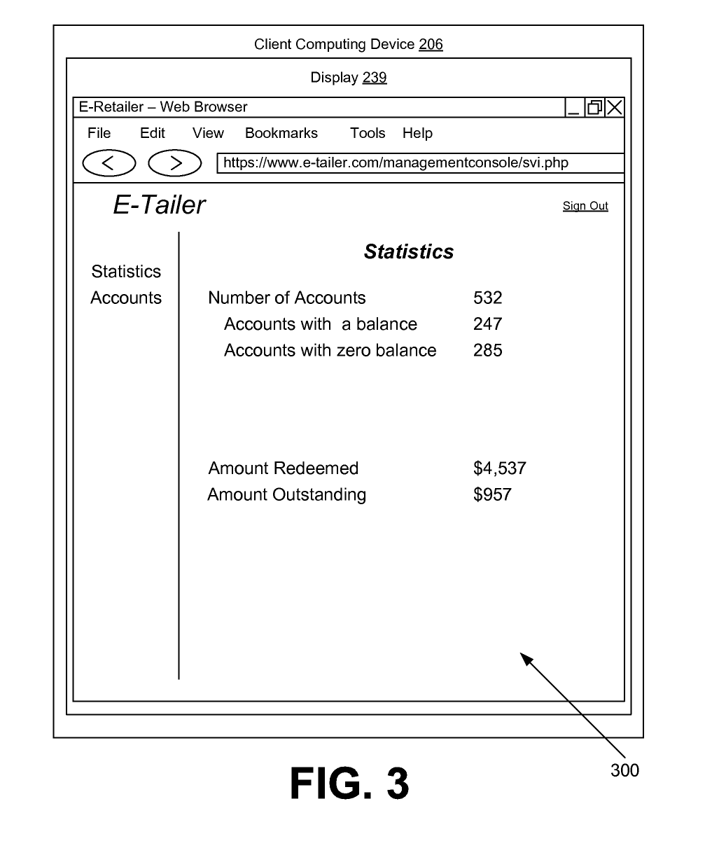

Referring next to FIG. 3, shown is an example user interface 300 corresponding to an embodiment of the user interface 246 depicted in FIG. 2. In this illustrative example, the user interface 300 includes a network page 229 (FIG. 2) rendered on a display 239 (FIG. 2) of a client device 206 (FIG. 2). The user interface 300 depicted permits a merchant/issuer of a closed-loop stored value payment instrument 226 (not pictured) to view an account activity report 236 (FIG. 2). A merchant may view various statistics associated with the closed-loop stored value payment instruments 226, including the total number of accounts or instruments issued, the number of accounts with a balance, and the number of accounts without a balance. In some embodiments, the user interface 300 may allow a merchant to view account activity for individual accounts, including transaction histories and account balances.

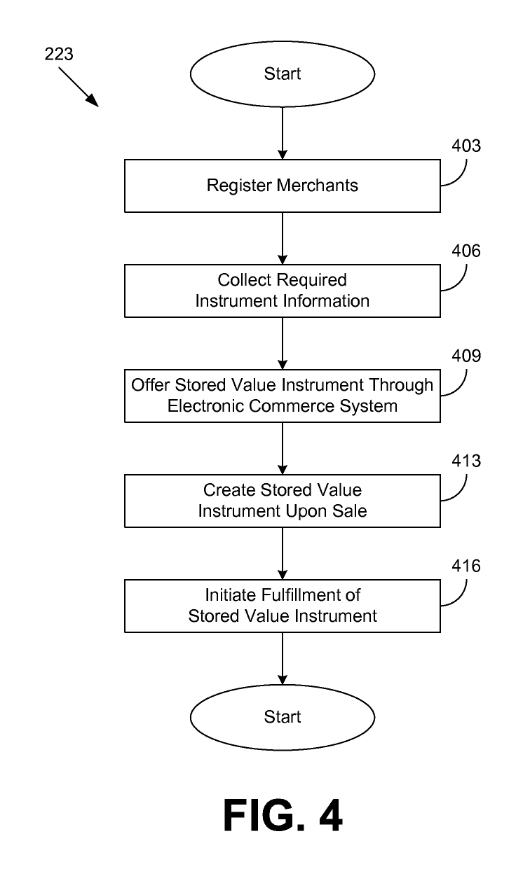

Referring next to FIG. 4, shown is a flowchart that provides one example of the operation of the brokerage application 223 according to various embodiments. It is understood that the flowchart of FIG. 4 provides merely an example of the many different types of functional arrangements that may be employed to implement the operation of the brokerage application 223 as described herein. As an alternative, the flowchart of FIG. 4 may be viewed as depicting an example of elements of a method implemented in the computing environment 203 (FIG. 2) according to one or more embodiments.

Beginning with box 403, the brokerage application 223 initiates registration of a merchant that desires to offer closed-loop stored value payment instruments 226 through the electronic commerce application 219 (FIG. 2). Merchant data 233 needed for registration may be obtained through a network page 229 (FIG. 2) or similar user interface 246. As part of the registration process, the user interface 246 may be configured to solicit the name of the merchant, preferences related to the sale of closed-loop stored value payment instruments 226, and credit related information. Preferences, for example, may include the “face value” or the denomination(s) in which closed-loop stored value payment instruments 226 should be sold. Credit related information may include a credit report or sufficient information to retrieve a credit report for the merchant, in order to gauge the credit risk for selling closed-loop stored value payment instruments 226.

In some embodiments, the user interface 246 may be further configured to solicit information related to the point-of-sale infrastructure of the merchant as part of the registration process. This may include whether the merchant has point-of-sale terminals as well as the make, model, and type of point-of-sale systems used by or available to the merchant. This may also include whether the merchant has relationships established with any current payment processors or aggregators. If the registering merchant indicates that it lacks point-of-sale infrastructure compatible with the brokerage application 223 or lacks a relationship with a payment processor or aggregator, the brokerage application 223 may provide another user interface 246 that identifies compatible point-of-sale infrastructure or payment processors.

Referring next to box 406, the brokerage application 223 collects information for the creation of a closed-loop stored value payment instrument 226 (FIG. 2). Such information may be obtained through a network page 229 or similar user interface 246. Such information may include, for example, a bank account or transaction account number into which funds from the sale of closed-loop stored value payment instruments 226 may be deposited.

Proceeding to box 409, the brokerage application 223 notifies the electronic commerce application 219 that it may begin offering the closed-loop stored value payment instrument 226 for sale.

Continuing to box 413 (and assuming that a customer has purchased a closed-loop stored value payment instrument 226 via the electronic commerce application 219), the brokerage application 223 instructs the printer 209 and the payment aggregator system 213 to create the closed-loop stored value payment instrument 226 in response to the sale through the electronic commerce application 219. Accordingly, the brokerage application 223 notifies a printing application 249 executing in a printer 209, of the sale. As part of the notification, the brokerage application 223 includes merchant data 233 related to the closed-loop stored value payment instrument.

The brokerage application 223 also notifies the payment aggregator system 213 of the sale of the closed-loop stored value payment instrument 226. The notification generally identifies the merchant with which the closed-loop stored value payment instrument 226 may be redeemed, the value 227 of closed-loop stored value payment instrument 226, the account number 228 to be used to identify the stored value payment instrument 226, and any other necessary data to permit the aggregation application 253 executing in the payment aggregator system 213 to manage transactions made with the closed-loop stored value payment instrument 226.

Moving next to box 416, the brokerage application 223 initiates fulfillment of the closed-loop stored value payment instrument 226 sold through the electronic commerce application 219. As part of fulfillment, the brokerage application 223 may provide a shipping address for the customer to the printer 209 (or operator of the printer 209) for direct shipment to the purchaser.

Those skilled in the art will recognize, however, that closed-loop stored value payment instruments 226 may have been printed on behalf of the merchant prior to purchase by the customer, e.g., following registration by the merchant with the brokerage application. In such embodiments, the brokerage application may initiate fulfillment of a previously printed closed-loop stored value payment instrument 226 to the shipping address of the customer. The printer 209 may be located in a fulfillment center associated with provider of the electronic commerce application 219 or the brokerage application 223, and shipped to the customer from the fulfillment center via the provider's fulfillment network. In yet other embodiments, closed-loop stored value payment instruments 226 printed on behalf of the merchant, e.g., following registration by the merchant with the brokerage application 223, may be shipped to one or more merchant locations so that the instruments may be purchased at such locations. Those skilled in the art will also recognize that in yet other embodiments in which the closed-loop stored value payment instrument 226 is embodied in digital form, such as a mobile payment application, that the brokerage application 223 may initiate fulfillment of the closed-loop stored value payment instrument by initiating electronic transfer to the customer of the mobile payment application to a computing device associated with the customer, or by otherwise making the mobile payment application available for installation on the customer's computing device.

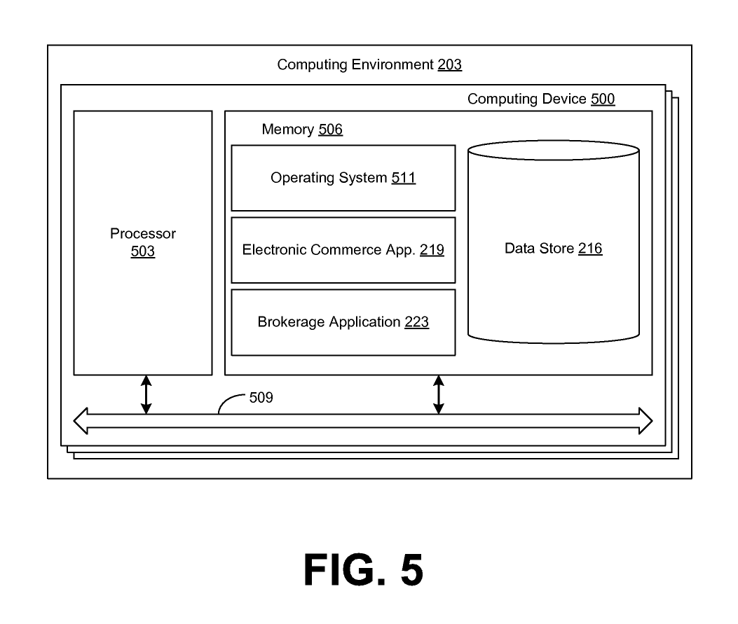

With reference to FIG. 5, shown is a schematic block diagram of the computing environment 203 according to an embodiment of the present disclosure. The computing environment 203 may include one or more computing devices 500. Each computing device 500 may include at least one processor circuit, for example, having a processor 503 and a memory 506, both of which may be coupled to a local interface 509. To this end, each computing device 500 may include, for example, at least one server computer or like device. The local interface 509 may include, for example, a data bus with an accompanying address/control bus or other bus structure as can be appreciated.

Stored in the memory 506 may be both data and several software components that are executable by the processor 503. In particular, stored in the memory 506 and executable by the processor 503 are the electronic commerce application 219, the brokerage application 223, and potentially other applications. Also stored in the memory 506 may be a data store 216 and other data. In addition, an operating system 511 may be stored in the memory 506 and executable by the processor 503.

It is understood that there may be other applications stored in the memory 506 and executable by the processor 503 as can be appreciated. Where any component discussed herein is implemented in the form of software, any one of a number of programming languages may be employed such as, for example, C, C++, C#, Objective C®, Java®, JavaScript®, Perl, PHP®, Visual Basic®, Python®, Ruby, Flash®, or other programming languages.

A number of software components may be stored in the memory 506 and are executable by the processor 503. In this respect, the term “executable” means a program file that is in a form that can ultimately be run by the processor 503. Examples of executable programs may be, for example, a compiled program that can be translated into machine code in a format that can be loaded into a random access portion of the memory 506 and run by the processor 503, source code that may be expressed in proper format such as object code that is capable of being loaded into a random access portion of the memory 506 and executed by the processor 503, or source code that may be interpreted by another executable program to generate instructions in a random access portion of the memory 506 to be executed by the processor 503, etc. An executable program may be stored in any portion or component of the memory 506 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other non-transitory computer-readable storage media.

The memory 506 may also include both volatile and nonvolatile memory and data storage components. Volatile components are those that do not retain data values upon loss of power. Nonvolatile components are those that retain data upon a loss of power. Thus, the memory 506 may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

Also, the processor 503 may represent multiple processors 503 and/or multiple processor cores and the memory 506 may represent multiple memories 506 that operate in parallel processing circuits, respectively. In such a case, the local interface 509 may be an appropriate network that facilitates communication between any two of the multiple processors 503, between any processor 503 and any of the memories 506, or between any two of the memories 506, etc. The local interface 509 may include additional systems designed to coordinate this communication, including, for example, performing load balancing. The processor 503 may be of electrical or of some other available construction.

Although the electronic commerce application 219, the brokerage application 223, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 4 shows illustrative functionality and operation of an implementation of the brokerage application 223. If embodied in software, each block may represent a module, segment, or portion of code that includes program instructions to implement the specified logical functions. The program instructions may be embodied in the form of source code that includes human-readable statements written in a programming language or machine code that includes numerical instructions recognizable by a suitable execution system such as a processor 503 in a computer system or other system. The machine code may be converted from the source code, etc. If embodied in hardware, each block may represent a circuit or a number of interconnected circuits to implement the specified logical functions.

Although the flowchart of FIG. 4 shows a specific order of execution, it is understood that the order of execution may differ from that which is depicted. For example, the order of execution of two or more blocks may be scrambled relative to the order shown. Also, two or more blocks shown in succession in FIG. 4 may be executed concurrently or with partial concurrence. Further, in some embodiments, one or more of the blocks shown in FIG. 4 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the electronic commerce application 219, the brokerage application 223, the printing application 249, and the aggregation application 253, that includes software or code can be embodied in any non-transitory computer-readable medium for use by or in connection with an instruction execution system such as, for example, a processor 503 in a computer system or other system. In this sense, the logic may include, for example, statements including instructions and declarations that can be fetched from the computer-readable medium and executed by the instruction execution system. In the context of the present disclosure, a “non-transitory computer-readable medium” can be any medium that can contain, store, or maintain the logic or application described herein for use by or in connection with the instruction execution system.

The non-transitory computer-readable medium can include any one of many physical media such as, for example, magnetic, optical, or semiconductor media. More specific examples of a suitable non-computer-readable medium would include, but are not limited to, magnetic tapes, magnetic floppy diskettes, magnetic hard drives, memory cards, solid-state drives, USB flash drives, or optical discs. Also, the non-transitory computer-readable medium may be a random access memory (RAM) including, for example, static random access memory (SRAM) and dynamic random access memory (DRAM), or magnetic random access memory (MRAM). In addition, the non-transitory computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the electronic commerce application 219, the brokerage application 223, the printing application 249, and the aggregation application 253, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 500, or on multiple computing devices in the same computing environment 203.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in a computing device, wherein the program, when executed, causes the computing device to at least:
obtain merchant data from a merchant who wishes to issue a closed-loop stored value payment instrument;
send the merchant data to a payment aggregator system so that the payment aggregator system can process, using the merchant data, transactions initiated using the closed-loop stored value payment instrument, on behalf of the merchant;
cause the closed-loop stored value payment instrument to be offered for sale via an electronic commerce system;
upon purchase by a customer of the closed-loop stored value payment instrument,
instruct a printer to print a physical card embodying the closed-loop stored value payment instrument;
provide the payment aggregator system a notification of the sale of the closed-loop stored value payment instrument so that the payment aggregator can activate the closed-loop stored value payment instrument; and
initiate fulfillment to the customer of the physical card embodying the closed-loop stored value payment instrument.

2. The non-transitory computer-readable medium of claim 1, wherein the closed-loop stored value payment instrument may be accessed with an application executing in a mobile computing device.

3. The non-transitory computer-readable medium of claim 1, wherein the program, when executed, further causes the computing device to at least:
generate an account activity report based at least upon activity of the closed-loop stored value payment instrument by the customer.

4. The non-transitory computer-readable medium of claim 1, wherein multiple closed-loop stored value payment instruments issued on behalf of the merchant are purchased via the electronic commerce system by different customers and the program, when executed, further causes the computing device to at least:
generate an account activity report based at least in part upon activity of the multiple closed-loop stored value payment instruments by the different customers.

5. A system comprising:
a physical data store configured to store merchant data; and
a computing device in communication with the physical data store, the computing device configured to at least:
obtain merchant data from a merchant who wishes to issue a closed-loop stored value payment instrument;
send the merchant data to a payment aggregator system to process transactions conducted using the closed-loop stored value payment instrument, on behalf of the merchant;
cause the closed-loop stored value payment instrument to be offered for acquisition through an electronic commerce system;
initiate creation of the closed-loop stored value payment instrument in response to acquisition of the stored value payment instrument by a customer; and
initiate fulfillment to the customer of the closed-loop stored value payment instrument in response to the acquisition.

6. The system of claim 5, wherein to initiate creation of the closed-loop stored value payment instrument, the computing device is further configured to at least:
notify a printer of the acquisition of the closed-loop stored value payment instrument; and
send the printer information for printing a physical embodiment of the closed-loop stored value payment instrument.

7. The system of claim 6, wherein the system is operated by a first party, the printer is operated by a second party, and the system and the printer are in data communication through a network.

8. The system of claim 5, wherein to initiate creation of the closed-loop stored value payment instrument, the computing device is further configured to at least:
notify a manufacturer of the acquisition of the closed-loop stored value payment instrument; and
send the manufacturer information for manufacturing a physical embodiment of the closed-loop stored value payment instrument.

9. The system of claim 5, wherein to initiate fulfillment of the closed-loop stored value payment instrument, the computing device is further configured to make a digital embodiment of the closed-loop stored value payment instrument available to the customer.

10. The system of claim 9, wherein the digital embodiment of the closed-loop stored value payment instrument comprises a mobile application that, when executed on a mobile computing device, causes the mobile computing device to transmit information related to the closed-loop stored value payment instrument to a point-of-sale system operated by the merchant.

11. The system of claim 5, wherein to initiate creation of the closed-loop stored value payment instrument, the computing device is further configured to at least:
notify a payment aggregator system of the acquisition of the closed-loop stored value payment instrument;
provide the payment aggregator system an instruction to create a ledger for the closed-loop stored value instrument; and
provide the payment aggregator system an instruction to activate the closed-loop stored value instrument.

12. The system of claim 11, wherein the system is operated by a first party, the payment aggregator system is operated by a second party, and the system and the payment aggregator system are in data communication through a network.

13. The system of claim 5, wherein the computing device is further configured to at least:
query a ledger for data related to a plurality of closed-loop stored value payment instruments; and
generate an account activity report based at least upon the data related to the plurality of closed-loop stored value payment instruments.

14. The system of claim 13, wherein the computing device is further configured to at least generate a network page that includes the account activity report in response to a request from another computing device for the network page.

15. The system of claim 13, wherein the account activity report includes data regarding at least one of a quantity of closed-loop stored value payment instruments acquired, or a total amount of currency available for redemption from a plurality of closed-loop stored value payment instruments.

16. The system of claim 13, wherein the account activity report includes at least one of an account number, a transaction history, or an account balance for each of the plurality of closed-loop stored value payment instruments.

17. A computer-implemented method comprising:
obtaining, via a computing device, merchant data from a merchant who wishes to issue a stored value payment instrument;
sending, via the computing device, the merchant data to a payment aggregator system to process transactions conducted using the stored value payment instrument, on behalf of the merchant;
initiating, via the computing device, creation of the stored value payment instrument on behalf of the merchant; and
initiating, via the computing device, fulfillment of the stored value payment instrument.

18. The computer-implemented method of claim 17, wherein initiating, via the computing device, fulfillment of the stored value payment instrument comprises instructing manufacture of the stored value payment instrument and instructing delivery of the manufactured stored value payment instrument to the merchant so that the merchant may offer the manufactured stored value payment instrument to customers.

19. The computer-implemented method of claim 17, further comprising:
causing, via the computing device, the stored value payment instrument to be listed on an electronic commerce system.

20. The computer-implemented method of claim 19, wherein initiating, via the computing device, fulfillment of the stored value payment instrument comprises instructing manufacture of the stored value payment instrument following purchase of the stored value payment instrument by a customer from the electronic commerce system and instructing delivery of the manufactured stored value payment instrument to the customer.

21. The computer-implemented method of claim 17, further comprising:
querying, via the computing device, an electronic ledger for data related to a plurality of stored value payment instruments; and
generating, via the computing device, an account activity report based at least upon the data related to the plurality of stored value payment instruments.

22. The computer-implemented method of claim 17, wherein creating the stored value payment instrument further comprises sending, via the computing device, merchant data and data related to a customer who has purchased the stored value payment instrument, to that payment aggregator system.

23. The computer-implemented method of claim 17, wherein the computing device and the electronic commerce system are operated by a party other than the merchant and the stored value payment instrument is redeemable with the merchant.

24. The computer-implemented method of claim 17, wherein the stored value payment instrument may be accessed using a mobile application that, when executed on a mobile computing device, causes the mobile computing device to transmit information related to the stored value payment instrument to a point-of-sale system operated by the merchant.

25. The computer-implemented method of claim 17, wherein the stored value payment instrument is a closed-loop stored value payment instrument.

26. The computer-implemented method of claim 17, wherein the merchant data comprises at least one of merchant name, a demand deposit account number for the merchant, a transactional banking account number for the merchant, a bank routing number associated with the merchant, point-of-sale infrastructure information for the merchant, or financial information related to the merchant.
